(19) United States
(12) Patent Application Publication
(10) Pub. No.: US 2014/0147698 A1
(43) Pub. Date: May 29, 2014

(54) OPTICAL MATERIAL AND OPTICAL ELEMENT CONTAINING SAME

(71) Applicant: Panasonic Corporation, Osaka (JP)

(72) Inventors: Takanori YOGO, Kyoto (JP); Shinya HASEGAWA, Kyoto (JP)

(73) Assignee: Panasonic Corporation, Osaka (JP)

(21) Appl. No.: 14/169,583

(22) Filed: Jan. 31, 2014

Related U.S. Application Data
(63) Continuation of application No. PCT/JP2012/005364, filed on Aug. 27, 2012.

(30) Foreign Application Priority Data
Aug. 26, 2011 (JP) 2011-184420

(51) Int. Cl. C09D 7/12

(52) U.S. Cl. CPC C09D 7/1216
USPC 428/702; 524/706

(57) ABSTRACT

Provided is a novel composite optical material with which positive abnormal dispersion can be obtained. The optical material includes a matrix material and inorganic fine particles, and the inorganic fine particles contain at least indium phosphorus oxide.

This is a continuation of International Application No. PCT/JP2012/005364, with an international filing date of Aug. 27, 2012, which claims the foreign priority of Japanese Patent Application No. 2011-184420, filed on Aug. 26, 2011, the entire contents of both of which are hereby incorporated by reference.

### BACKGROUND OF THE INVENTION

1. Field of the Invention

The present disclosure relates to an optical material in which inorganic fine particles are dispersed in a matrix material such as a resin. The present disclosure also relates to optical elements, such as lenses and hybrid lenses, each containing the optical material.

2. Description of Related Art

Optical materials in which inorganic fine particles are dispersed in a matrix material such as a resin to increase the range of their optical properties are known (hereinafter, materials of such a structure are referred to as “composite materials”). For example, JP 4217032 B discloses an optical element having an Abbe number of 80 or more and made of a composite material containing an amorphous fluororesin and fine particles having a size of less than 400 nm.

Various optical properties of composite materials can be controlled by selecting the type of matrix materials and inorganic fine particles and adjusting the content of the inorganic fine particles. In particular, in the composite material disclosed in JP 4217032 B, positive abnormal dispersion can be obtained if a fluoride is selected as the fine particles, and it is considered that the magnitude of the positive abnormal dispersion can be adjusted to some extent by adjusting the content of the fine particles.

Materials of various optical properties are required for optical elements, such as lenses. Therefore, composite materials whose optical properties can be controlled in the manner as described above, in particular, composite materials having positive abnormal dispersion, are very useful in the field of optics, and the development of novel composite materials having positive abnormal dispersion is required.

### SUMMARY OF THE INVENTION

In view of this, one non-limiting and exemplary embodiment provides a novel composite optical material with which positive abnormal dispersion can be obtained.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

In one general aspect, the techniques disclosed here feature an optical material including: a matrix material; and inorganic fine particles. The inorganic fine particles contain at least indium phosphorus oxide.

The optical material described above provides a novel composite optical material with which positive abnormal dispersion can be obtained.

### BRIEF DESCRIPTION OF THE DRAWINGS

FIG. 1 is a schematic diagram showing a composite material 100.

FIG. 2 is a graph for explaining an effective particle diameter.

FIG. 3 is a graph showing a relationship between the Abbe number and the refractive index of the composite material 100.

FIG. 4 is a graph showing a relationship between the Abbe number and the partial dispersion ratio of the composite material 100.

FIG. 5 is a cross-sectional view showing an example of a structure of a lens 200.

FIG. 6 is a cross-sectional view showing an example of a structure of a hybrid lens 300.

### DETAILED DESCRIPTION

Hereinafter, the present disclosure will be described in detail by way of specific embodiments, but the present disclosure is not limited to these embodiments and can be modified as appropriate within the technical scope of the present disclosure.

### First Embodiment

The first embodiment is described below with reference to the drawings.

[1. Composite Material]

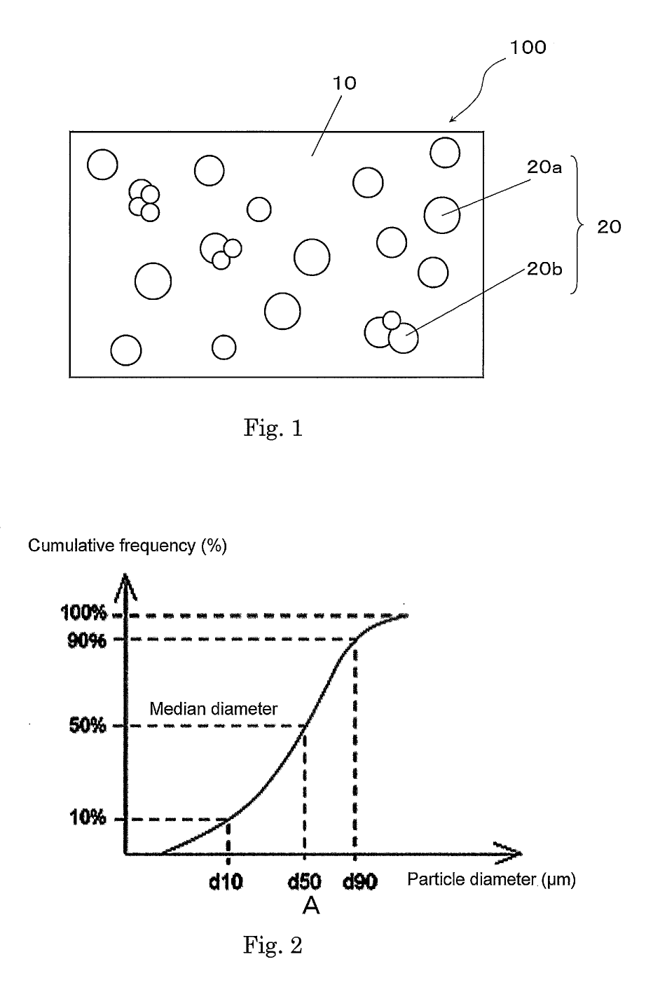

FIG. 1 is a schematic diagram showing a composite material 100 of the present embodiment. The composite material 100 of the present embodiment is composed of a resin 10 as a matrix material and inorganic fine particles 20 containing at least indium phosphorus oxide (a phosphorus-doped indium oxide compound). The inorganic fine particles 20 are dispersed in the resin 10.

[2. Inorganic Fine Particles]

The inorganic fine particles 20 may be either aggregated particles or non-aggregated particles. Generally, the inorganic fine particles 20 include primary particles 20a and secondary particles 20b which are aggregates of the primary particles 20a. The dispersion state of the inorganic fine particles 20 is not particularly limited because a desired effect can be obtained as long as the inorganic fine particles are present in the matrix material. However, it is desirable that the inorganic fine particles 20 be uniformly dispersed in the resin 10. As used herein, the inorganic fine particles 20 uniformly dispersed in the resin 10 means that the primary particles 20a and the secondary particles 20b of the inorganic fine particles 20 are substantially uniformly dispersed in the composite material 100 without being localized in any particular region in the composite material 100. It is desirable that the particles have good dispersibility in order to control the light transmittance of the optical material. Therefore, it is desirable that the inorganic fine particles 20 consist of only the primary particles 20a.

The particle diameter of the inorganic fine particles 20 is a beneficial factor in ensuring the light transmittance of the composite material 100 in which the inorganic fine particles 20 containing indium phosphorus oxide are dispersed. When the particle diameter of the inorganic fine particles 20 is sufficiently smaller than the wavelength of light, the composite material 100 in which such inorganic fine particles 20 are dispersed can be regarded as a homogeneous medium without variations in the refractive index. Therefore, the maximum particle diameter of the inorganic fine particles 20 is desirably equal to or smaller than the wavelength of visible light. For example, since the wavelength of visible light is in the range of 400 nm or more and 700 nm or less, the maximum particle diameter of the inorganic fine particles 20 is desirably 400 nm or less. The maximum particle diameter of the inorganic fine particles 20 can be determined by taking a scanning electron microscope (SEM) photograph of the inorganic fine particles 20 and measuring the particle diameter of the largest inorganic fine particle 20 (the secondary particle diameter if the largest particle is a secondary particle).

When the particle diameter of the inorganic fine particles 20 is larger than one fourth of the wavelength of light, the light transmittance may decrease due to Rayleigh scattering. Therefore, it is desirable that the effective particle diameter of the inorganic fine particles 20 be 100 nm or less in order to achieve high light transmittance in the visible light region. However, when the effective particle diameter of the inorganic fine particles is less than 1 nm, fluorescence may occur if the inorganic fine particles are made of a material that exhibits quantum effects. This fluorescence may affect the properties of an optical component formed using the composite material 100. From the viewpoints described above, the effective particle diameter of the inorganic fine particles is desirably in the range of 1 nm or more and 100 nm or less, and more desirably in the range of 1 nm or more and 50 nm or less. In particular, it is further desirable that the particle diameter of the inorganic fine particles 20 be 20 nm or less because the effect of Rayleigh scattering is very small while the light transmittance of the composite material 100 is particularly high.

The effective particle diameter is described herein with reference to FIG. 2. In FIG. 2, the horizontal axis represents the particle diameters of the inorganic fine particles, and the left vertical axis represents the cumulative frequencies of the inorganic fine particles with respect to the respective particle diameters represented on the horizontal axis. Here, in the case where the inorganic fine particles are aggregated, the particle diameters on the horizontal axis represent the diameters of secondary particles in an aggregated state. As used herein, the effective particle diameter refers to the median particle diameter (median diameter: d50) A corresponding to a cumulative frequency of 50% in a graph showing the particle diameter frequency distribution of the inorganic fine particles as shown in FIG. 2. In order to determine the accurate value of the effective particle diameter, it is desirable, for example, to take a scanning electron microscope (SEM) photograph of the inorganic fine particles 20 and measure the diameters of at least 200 of the inorganic fine particles.

As described above, the composite material 100 of the present embodiment is obtained by dispersing the inorganic fine particles 20 containing at least indium phosphorus oxide in the resin 10. It has been found that since the composite material 100 thus obtained can exhibit low dispersion (high Abbe number) and large positive abnormal dispersion as described later, it is effective to use indium phosphorus oxide as the inorganic fine particles 20.

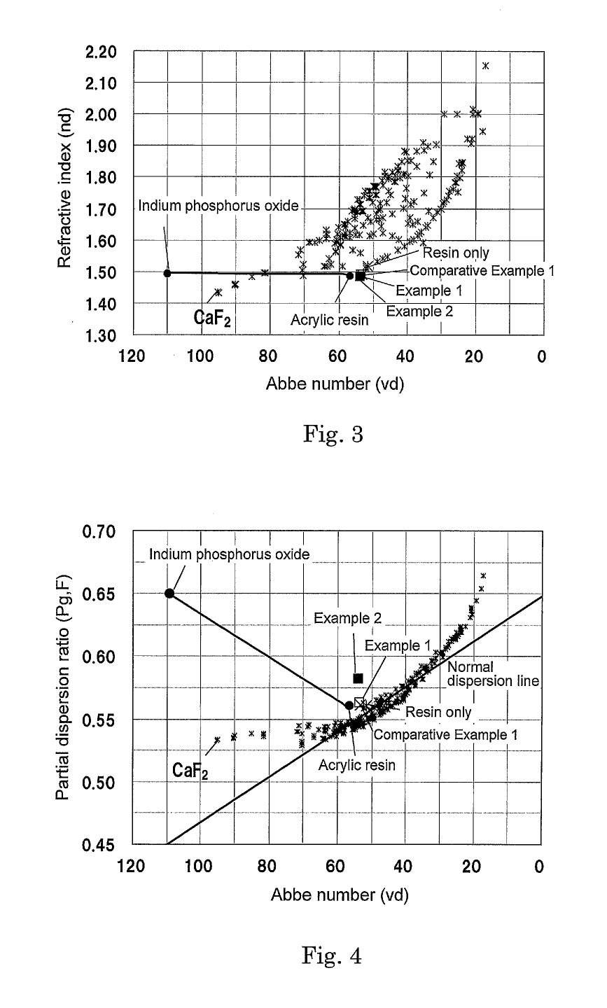

FIG. 3 is a graph showing the relationship between the refractive index nd at the d-line (wavelength of 587.6 nm) and the Abbe number vd representing the wavelength dispersion for various inorganic materials. The Abbe number vd is a numerical value defined by the following formula (1). In the formula (1), nF and nC are the refractive indices at the F-line (wavelength of 486.1 nm) and the C-line (wavelength of 656.3 nm), respectively.

νd=(nd−1)/(nF−nC) (1)

FIG. 4 is a graph showing the relationship between the Abbe number vd representing the wavelength dispersion and the partial dispersion ratio Pg,F representing the dispersions at the g-line (wavelength of 435.8 nm) and the F-line (wavelength of 486.1 nm) for various inorganic materials. The partial dispersion ratio Pg,F is a numerical value defined by the following formula (2). In the formula (2), nF and nC are as defined above, and ng is the refractive index at the g-line (wavelength of 435.8 nm).

Pg,F=(ng−nF)/(nF−nC) (2)

Abnormal dispersion is represented by ΔPg,F, which is the deviation of the Pg,F of each material from a point on the reference line of normal dispersion glass corresponding to the vd of the material.

Herein, based on the standards of HOYA Corporation, ΔPg,F is calculated using a straight line (normal dispersion line in FIG. 4) passing through the coordinates of glass types C7 (nd of 1.51, vd of 60.5, and Pg,F of 0.54) and F2 (nd of 1.62, vd of 36.3, and Pg,F of 0.58) as the reference line of normal dispersion glass.

As shown in FIG. 3 and FIG. 4, indium phosphorus oxide has the following optical properties: a refractive index nd at the d-line of 1.495, an Abbe number vd of 109.5, and a partial dispersion ratio Pg,F of 0.65. In particular, the abnormal dispersion ΔPg,F of indium phosphorus oxide is a large value of +0.20. This value is greater than the abnormal dispersion ΔPg,F value +0.06 of calcium fluoride (CaF₂) known as an abnormal dispersion material. This fact shows that indium phosphorus oxide is a material having a very large abnormal dispersion property.

As described above, indium phosphorus oxide has low dispersion and large positive abnormal dispersion. The use of the composite materials 100 including appropriately combined inorganic fine particles 20 containing this indium phosphorus oxide and resin base materials 10 having various refractive indices makes it possible to prepare a wide variety of materials having the optical properties of both low dispersion and positive abnormal dispersion, which are difficult to obtain using conventional fluoride-containing composite materials. As a result, these materials offer greater flexibility in designing optical components than conventional materials.

If the amount of phosphorus contained in indium phosphorus oxide is too large, indium phosphide is produced and may affect the properties of optical components formed using the composite material 100. Therefore, it is desirable that the amount of phosphorus be in the range of 0<x≦0.2, when the composition ratio of phosphorus to oxygen is expressed by x:1−x.

[3. Resin Material]

As the resin 10, resins having high light transmittance selected from resins such as thermoplastic resins, thermosetting resins, and energy ray-curable resins can be used. For example, acrylic resins; methacrylic resins such as polymethyl methacrylate; epoxy resins; polyester resins such as polyethylene terephthalate, polybutylene terephthalate, and polycaprolactone; polystyrene resins such as polystyrene; olefin resins such as polypropylene; polyamide resins such as nylon; polyimide resins such as polyimide and polyether imide; polyvinyl alcohol; butyral resins; vinyl acetate resins; alicyclic polyolefin resins, silicone resins, and amorphous fluororesins may be used. Engineering plastics such as polycarbonate, liquid crystal polymers, polyphenylene ether, polysulfone, polyether sulfone, polyarylate and amorphous polyolefin also may be used. Mixtures and copolymers of these resins (polymers) also may be used. Resins obtained by modifying these resins also may be used.

Among these, acrylic resins, methacrylic resins, epoxy resins, polyimide resins, butyral resins, alicyclic polyolefin resins, and polycarbonate have high transparency and good moldability. These resins can have d-line refractive indices ranging from 1.4 to 1.7 by selecting a specific molecular skeleton.

The Abbe number vm of the resin 10 is not particularly limited. Needless to say, the Abbe number vCOM of the composite material 100 obtained by dispersing the inorganic fine particles 20 increases as the Abbe number vm of the resin 10 serving as a base material gets higher. In particular, it is desirable to use a resin having an Abbe number vm of 45 or more as the resin 10 because the use of such a resin makes it possible to obtain a composite material having an Abbe number vCOM of 40 or more and having optical properties suitable enough for use in optical components such as lenses. Examples of the resin having an Abbe number vm of 45 or more include alicyclic polyolefin resins having an alicyclic hydrocarbon group in the skeleton, silicone resins having a siloxane structure, and amorphous fluororesins having a fluorine atom in the main chain. The resin having an Abbe number of 45 or more is, of course, not limited to these resins.

[4. Optical Properties of Composite Material]

The refractive index of the composite material 100 can be estimated from the refractive indices of the inorganic fine particles 20 and the resin 10, for example, based on the Maxwell-Garnett theory represented by the following formula (3). It is also possible to estimate the Abbe number of the composite material 100 from the following formula (3) by estimating the refractive indices at the d-line, the F-line, and the C-line, respectively. Conversely, the weight ratio between the resin 10 and the inorganic fine particles 20 may be determined from the estimation based on this theory.

$${n}_{COM λ}^{2} = \frac{{n}_{p λ}^{2} + 2 {n}_{m λ}^{2} + 2 P ( {n}_{p λ}^{2} - {n}_{m λ}^{2} )}{{n}_{p λ}^{2} + 2 {n}_{m λ}^{2} - P ( {n}_{p λ}^{2} - {n}_{m λ}^{2} )} {n}_{m λ}^{2} \qquad ( 3 )$$

In the formula (3), nCOMA is the average refractive index of the composite material 100 at a specific wavelength λ, and npλ and nmλ are the refractive indices of the inorganic fine particles 20 and the resin 10, respectively, at this wavelength A. P is the volume ratio of the inorganic fine particles 20 to the composite material 100 as a whole. In the case where the inorganic fine particles 20 absorb light or where the inorganic fine particles 20 contain metal, complex refractive indices are used as the refractive indices in the formula (4) for the calculation. It should be noted that the formula (3) holds in the case of npλ≧nmλ, and in the case of npλ<nmλ, the refractive indices are estimated using the following formula (4).

$${n}_{COM λ}^{2} = \frac{{n}_{m λ}^{2} + 2 {n}_{p λ}^{2} + 2 ( 1 - P ) ( {n}_{m λ}^{2} - {n}_{p λ}^{2} )}{{n}_{m λ}^{2} + 2 {n}_{p λ}^{2} - ( 1 - P ) ( {n}_{m λ}^{2} - {n}_{p λ}^{2} )} {n}_{p λ}^{2} \qquad ( 4 )$$

The actual refractive index of the composite material 100 can be evaluated by film-forming or molding the prepared composite material 100 into a shape suitable for a measurement method to be used, and actually measuring the resulting formed or molded product by the method. The method is, for example, a spectroscopic measurement method, such as an ellipsometric method, an Abeles method, an optical waveguide method or a spectral reflectance method, or a prism-coupler method.

The optical properties of the composite material 100 calculated using the above-mentioned Maxwell-Garnett theory is described. Here, as an example, the case where indium phosphorus oxide is used as the inorganic fine particles 20 and an acrylic resin is used as the resin 10 is described.

In each of FIG. 3 and FIG. 4, a point indicating the optical property of indium phosphorus oxide, a point indicating the optical property of the acrylic resin, and a solid line connecting these two points are shown. The composite material 100 can exhibit the optical properties indicated on the solid lines shown in FIG. 3 and FIG. 4 by adjusting the proportions of indium phosphorus oxide and the acrylic resin contained in the composite material 100. When the composite material 100 contains a high proportion of indium phosphorus oxide, the values of the optical properties of the composite material 100 are close to those of indium phosphorus oxide. When the composite material 100 contains a high proportion of the acrylic resin, the values of the optical properties of the composite material 100 are close to those of the acrylic resin. The composite material 100 having desired optical properties can be formed by adjusting the proportions of indium phosphorus oxide and the acrylic resin.

In practice, if the content of the inorganic fine particles 20 in the composite material 100 is too low, the effect of adjustment for the optical properties derived from the inorganic fine particles 20 may not be fully obtained. Therefore, the content thereof is desirably 1 wt. % or more, more desirably 5 wt. % or more, and further desirably 10 wt. % or more, with respect to the total weight of the composite material 100 (optical material). On the other hand, when the content of the inorganic fine particles 20 is too high, the fluidity of the composite material 100 decreases, which may make it difficult to mold it or even to add the inorganic fine particles 20 into the resin 10. Thus, the content is desirably 80 wt. % or less, more desirably 60 wt. % or less, and further desirably 40 wt. % or less.

[5. Production Method]

Next, the method for producing the composite material 100 of the present embodiment is described. First, the method for forming the inorganic fine particles 20 is described. The inorganic fine particles 20 can be synthesized by a liquid phase method (such as a coprecipitation method, a sol-gel method, or a metal complex decomposition method), or by a vapor phase method. Instead, a bulk may be ground into fine particles by a grinding method using a ball mill or a bead mill so as to form the inorganic fine particles 20. Examples of the raw materials of indium phosphorus oxide contained in the inorganic fine particles 20 are as follows. Examples of the indium source include indium oxides, indium chlorides, indium hydroxides, indium nitrates, indium carbonates, indium sulfates, indium alkoxides (such as indium tetraethoxide, indium tetra-i-propoxide, indium tetra-n-propoxide, indium tetra-n-butoxide, indium tetra-sec-butoxide, and indium tetra-tert-butoxide), indium chelate compounds (such as bis(acetylacetone) indium and tri-n-butoxide indium monoethylacetoacetate), and indium ammonium carbonate. Examples of the phosphorus source include ammonium phosphates, orthophosphates, polyphosphates (such as pyrophosphate, tripolyphosphate, trimetaphosphate, and tetrametaphosphate), phosphoric acid esters (such as trimethyl phosphate and triethyl phosphate), and condensed phosphoric acids (such as metaphosphoric acid).

Next, a method for preparing the composite material of the present embodiment is described.

There is no particular limitation on the method for preparing the composite material 100 obtained by dispersing the inorganic fine particles 20 formed by the above-described method in the resin 10 serving as the base material. The composite material 100 may be prepared by a physical method or by a chemical method. For example, the composite material can be prepared by any of the following methods.

Method (1): A resin or a solution in which a resin is dissolved is mechanically and/or physically mixed with inorganic fine particles.

Method (2): A raw material of a resin (a monomer, an oligomer, or the like) is mechanically and/or physically mixed with inorganic fine particles to obtain a mixture, and then the raw material of the resin is polymerized.

Method (3): A resin or a solution in which a resin is dissolved is mixed with raw materials of inorganic fine particles, and then the raw materials of the inorganic fine particles are reacted so as to form the inorganic fine particles in the resin.

Method (4): After a raw material of a resin (a monomer, an oligomer, or the like) is mixed with raw materials of inorganic fine particles, a step of reacting the raw materials of the inorganic fine particles so as to synthesize the inorganic fine particles and a step of polymerizing the raw material of the resin so as to synthesize the resin are performed.

The above methods (1) and (2) are advantageous in that various pre-formed inorganic fine particles can be used and that composite materials can be prepared by a general-purpose dispersing machine. The above methods (3) and (4) require chemical reactions, and usable materials are limited. However, since the materials are mixed at the molecular level in these methods, they are advantageous in that the dispersibility of the inorganic fine particles can be enhanced.

In the above methods, there is no particular limitation on the order of mixing inorganic fine particles or the raw materials of the inorganic fine particles with a resin or the raw material of the resin. A desired order can be selected as appropriate. For example, the resin or the raw material of the resin or a solution in which the resin or the raw material of the resin is dissolved may be added to a solution in which inorganic fine particles having a primary particle diameter substantially in the range of 1 nm to 100 nm are dispersed to mix them mechanically and/or physically. The production method of the composite material 100 is not particularly limited as long as the effect of the present disclosure can be obtained.

The composite material 100 may contain components other than the inorganic fine particles 20 and the resin 10 serving as the base material as long as the effect of the present disclosure can be obtained. For example, a dispersing agent or a surfactant that improves the dispersibility of the inorganic fine particles 20 in the resin 10, or a dye or a pigment that absorbs electromagnetic waves within specific range of wavelengths may coexist in the composite material 100, although not shown in the drawings.

### Second Embodiment

In the first embodiment described above, the composite material 100 including the matrix material containing the resin 10 and the inorganic fine particles 20 containing indium phosphorus oxide has been described. The second embodiment is an optical element containing this composite material 100.

The optical element is, for example, a lens, a prism, an optical filter, or a diffractive optical element, and the optical element is desirably a lens or a diffractive optical element. Hereinafter, the case where the optical element of the present embodiment is a lens is described specifically.

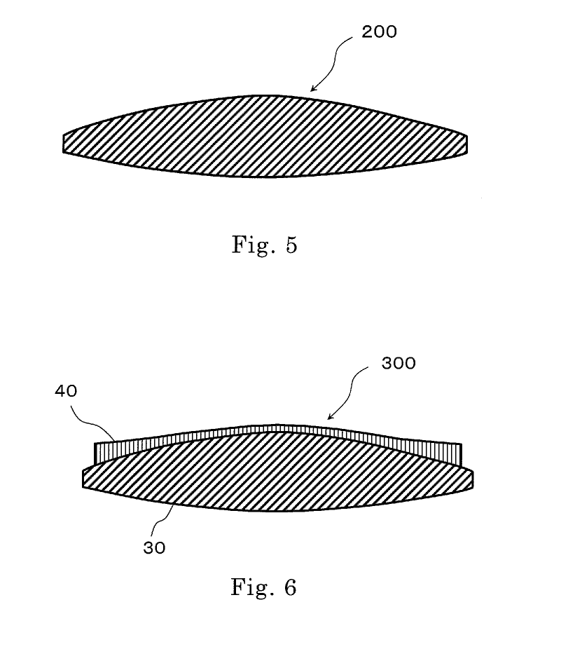

One configuration of the present embodiment is a lens 200 containing the composite material 100, as shown in FIG. 5. In FIG. 5, the lens 200 itself contains the composite material 100. The lens 200 can be produced using the composite material 100 in accordance with known techniques. For example, the lens 200 can be produced by molding the composite material 100 in accordance with a known technique, polishing a bulk of the composite material 100, or putting the raw material of the resin 10 (a monomer, an oligomer, or the like) mixed with the inorganic fine particles 20 into a mold so as to polymerize the raw material therein.

Another configuration of the present embodiment is a hybrid lens 300 including a lens 30 and a layer 40 formed on the surface of the lens 30 and containing the composite material 100, as shown in FIG. 6. The hybrid lens 300 can be produced in accordance with known techniques.

In FIG. 5 and FIG. 6, both surfaces of the lens 200 and the hybrid lens 300 are convex, but at least one of the surfaces may be concave. These lenses are designed as appropriate for the required optical properties. In the hybrid lens 300, the layer 40 is provided on one of the surfaces of the lens 30, but the layers 40 may be provided on both of the surfaces of the lens 30.

### EXAMPLES

Hereinafter, the present disclosure will be described in more detail with reference to Examples and Comparative Examples, but the present disclosure is not limited to these examples.

### Example 1

Indium nitrate trihydrate was dissolved in pure water to prepare an aqueous indium nitrate solution with a concentration of 0.02 M. To the aqueous solution, 25 ppm by weight of phosphoric acid relative to pure water was added. To the resulting mixture, 100 moles of decanoic acid per mole of indium was added. The mixture thus prepared was placed in a reactor, and heated to 400° C. with stirring and allowed to react for 20 minutes. Then, the mixture was rapidly cooled to stop the reaction. The pressure reached to about 40 MPa during the heating. Here, the reaction product was separated into a decanoic acid layer and an aqueous layer, and indium phosphorus oxide fine particles modified with decanoic acid were dispersed in the decanoic acid layer. Therefore, the decanoic acid layer was extracted, and ethanol was added to the layer to precipitate the indium phosphorus oxide fine particles. The indium phosphorus oxide fine particles thus precipitated were collected and washed with ethanol. Thus, an ethanol slurry of indium phosphorus oxide fine particles was obtained. The maximum particle diameter and the effective particle diameter of the indium phosphorus oxide fine particles were 90.1 nm and 45.2 nm, respectively, as obtained from the SEM photographs thereof.

The slurry containing the indium phosphorus oxide fine particles thus obtained were mixed with a photocurable acrylate monomer (trade name “M-8060”, manufactured by Toagosei) and a polymerization initiator (trade name “Irgacure 754”, manufactured by BASF), and the solvent was removed from the mixture under vacuum. The resulting mixture was cured with ultraviolet radiation. Thus, a composite material was obtained. The content of the indium phosphorus oxide fine particles in the composite material was 1.5 wt. %.

### Example 2

A composite material of Example 2 was obtained in the same manner as in Example 1, except that 50 ppm by weight of phosphoric acid relative to pure water was used in the process of synthesizing indium phosphorus oxide in Example 1. The maximum particle diameter and the effective particle diameter of the indium phosphorus oxide fine particles were 86.5 nm and 41.6 nm, respectively, as obtained from the SEM photographs thereof. The content of the indium phosphorus oxide fine particles in the composite material was 1.6 wt. %.

### Comparative Example 1

A mixture of a photocurable acrylate monomer (trade name “M-8060”, manufactured by Toagosei) and a polymerization initiator (trade name “Irgacure 754”, manufactured by BASF) was cured with ultraviolet radiation. Thus, a cured material was obtained as a material of Comparative Example 1.

### Comparative Example 2

An ethanol slurry of indium oxide fine particles which were not doped with phosphorus was obtained in the same manner as in Example 1, except that phosphoric acid was not added in the process of synthesizing indium phosphorus oxide in Example 1.

The slurry containing the indium oxide fine particles thus obtained were mixed with a photocurable acrylate monomer (trade name “M-8060”, manufactured by Toagosei) and a polymerization initiator (trade name “Irgacure 754”, manufactured by BASF), and the solvent was removed from the mixture under vacuum. The resulting mixture was cured with ultraviolet radiation. Thus, a composite material of Comparative Example 2 was obtained. The content of the indium fine particles in the composite material was 1.5 wt. %.

The g-line, F-line, d-line, and C-line refractive indices of the materials of Examples and Comparative Examples were measured using a precision refractometer KPR-200 manufactured by Shimadzu Device Corporation, and the Abbe numbers vd and ΔPg,F values were calculated from the formulae mentioned above. Table 1 and FIGS. 3 and 4 show the results.

TABLE 1

| Indium | | | | | | | |
|---|---|---|---|---|---|---|---|
| Phosphorus | | | | | | | |
| Oxide | | | | | | | |
| (In₂O₃:P) | Components | g-line | F-line | d-line | C-line | vd | ΔPgF |
| Com. Ex. 1 | Resin only (M8060) | 1.5308 | 1.5252 | 1.5182 | 1.5152 | 51.61 | +0.005 |
| Com. Ex. 2 | Resin + Non-doped | 1.5014 | 1.4962 | 1.4898 | 1.4871 | 53.30 | +0.009 |
| Ex. 1 | Resin + In₂O₃:P | 1.5013 | 1.4961 | 1.4897 | 1.4870 | 53.52 | +0.011 |
| | 25 ppm | | | | | | |
| Ex. 2 | Resin + In₂O₃:P | 1.4953 | 1.4901 | 1.4837 | 1.4811 | 53.93 | +0.031 |
| | 50 ppm | | | | | | |

The results shown in Table 1 and FIGS. 3 and 4 reveal that the optical materials of Examples, whose optical properties are affected by the optical properties of indium phosphorus oxide, exhibit higher Abbe numbers and larger positive abnormal dispersion than the material of Comparative Example containing only the resin. Therefore, it is found that the use of indium phosphorus oxide as inorganic fine particles for use in a composite material makes it possible to obtain an optical material having the optical properties of low dispersion and large positive abnormal dispersion.

The present disclosure may be embodied in other forms without departing from the spirit or essential characteristics thereof. The embodiments disclosed in this specification are to be considered in all respects as illustrative and not limiting. The scope of the present disclosure is indicated by the appended claims rather than by the foregoing description, and all changes which come within the meaning and range of equivalency of the claims are intended to be embraced therein.

### INDUSTRIAL APPLICABILITY

The optical material of the present disclosure can be suitably used for optical elements such as lenses, prisms, optical filters, and diffractive optical elements.

What is claimed is:

1. An optical material comprising:
a matrix material; and
inorganic fine particles,
wherein the inorganic fine particles contain at least indium phosphorus oxide.

2. An optical element comprising the optical material according to claim 1.

3. A lens comprising the optical material according to claim 1.

4. A hybrid lens comprising:
a lens; and
a layer formed on a surface of the lens and containing the optical material according to claim 1.
